(19) United States
(12) Patent Application Publication
(10) Pub. No.: US 2003/0001820 A1
(43) Pub. Date: Jan. 2, 2003

(54) Wireless keyboard based voice control module with display unit

(76) Inventor: Shaw-Yuan Hou, Taipei (TW)

Correspondence Address: Dougherty & Troxell, ONE SKYLINE PLACE, SUITE 1404, 5205 LEESBURG PIKE, FALLS CHURCH, VA, 22041, US

(21) Appl. No.: 09/891,360

(22) Filed: Jun. 27, 2001

(51) Int. Cl. G09G 5/00

(52) U.S. Cl. 345/168

(57) ABSTRACT

A wireless-keyboard based voice-control module is proposed, which is adapted for installation in a wireless keyboard for remote control of one or more electrical apparatuses, such as a personal computer (PC), a TV-based Internet-access box, a TV set, a DVD player, a stereo unit, an air conditioner, and so on, for the purpose of allowing the user to remotely turn on/off and control the operations of these electrical apparatuses through voice-activation by way of the wireless keyboard. The proposed voice-control module comprises voice input means which can pick up the user's natural voice command and converting it into digital voice signal. A remote-control code database is used for storing a predefined set of remote-control codes and corresponding voice commands; and a voice-recognition unit is used to perform a voice recognition algorithm to recognize the user's voice command, and which can further retrieve the corresponding remote-control code from the remote-control code database. Finally, a wireless signal emitter, such as infrared signal emitter is used to modulate the retrieved remote-control code into a wireless signal and emit the wireless signal to the electrical apparatuses to cause one or more of the electrical apparatuses to operate accordingly.

### BACKGROUND OF THE INVENTION

1. Field of the Invention

This invention relates to voice-control technology, and more particularly, to a wireless-keyboard based voice-control module with display unit, which is designed specifically for use on a wireless keyboard to allow the user to remotely control the operations of various kinds of remotely-controllable electrical apparatuses, such as a personal computer (PC), a TV-based Internet-access box, a TV set, a DVD player, a stereo unit, an air conditioner, and so on, through voice activation by way of the wireless keyboard.

2. Description of Related Art

A wireless keyboard is a peripheral data input device for a computer system or an TV-based Internet-access box. It allows the user to perform remote data input to the PC and Internet-access box without having to be connected via cables.

Access to Internet has been evolved from narrowband to broadband. One common way of broadband Internet link is through cable TV network, which allows the user to use a cable-linked TV as monitor and gain access to the Internet. To allow a TV set to be linked to the Internet, the TV set should be coupled to a wireless keyboard and an Internet-access box that functions like the main unit of a PC, and the user can control the operations of the Internet through the wireless keyboard.

One drawback to the use of conventional wireless keyboards, however, is that it nevertheless requires the user to manually press on the many keys on the wireless keyboard in order to input a desired character string or control code to the PC or TV-based Internet-access box, which is quite laborious and time-wasting, particularly when inputting a lengthy character string or sequence of control codes.

In the room where PC or TV is installed, there are usually installed other various kinds of electrical apparatuses, such as DVD players, stereo units, and air conditioners. These electrical apparatuses typically each come with a dedicated remote controller that allows the user to remotely control the operations of these electrical apparatuses. Therefore, for five different kinds of electrical apparatuses, for example, it requires the user to use five different kinds of dedicated remote controllers for the control of each of these electrical apparatuses, which is quite inconvenient for the user. Moreover, the user is nevertheless required to manually press control buttons provided on the panel of the remote controller to activate a certain control function, which is still quite laborious and inconvenient. For a combined system of two or more electrical apparatuses, such as a combined system of a TV set and a DVD player, since these two electrical apparatuses each have their own dedicated remote controllers, it would be inconvenient for the user to use one remote controller to turn on the TV set and then the other remote controller to turn on the DVD player.

There are various kinds of voice-control devices available on the consumer electronics market. These voice-control devices allow the user to preset voice commands and corresponding codes. One drawback to these conventional voice-control devices, however, is that they lack the provision of a display unit to display the user-defined codes for user verification.

There exists therefore a need in the consumer electronics market for a voice-control module with display unit for use on a wireless keyboard that allows the user to remotely control the operations of various kinds of electrical apparatuses, such as a personal computer (PC), a TV-based Internet-access box, a TV set, a DVD player, a stereo unit, an air conditioner, and so on, through voice activation by way of the wireless keyboard.

### SUMMARY OF THE INVENTION

It is therefore an objective of this invention to provide a wireless-keyboard based voice-control module with display unit, which allows the user to remotely control the operations of various kinds of electrical apparatuses, such as personal computer (PC), Internet-linked TV, TV set, DVD player, stereo unit, air conditioner, and so on, through voice activation by way of a wireless keyboard.

In accordance with the foregoing and other objectives, the invention proposes a novel wireless-keyboard based voice-control module.

The wireless-keyboard based voice-control module of the invention comprises: (a) a display unit, which is capable of displaying user-input alphanumeric characters representative of user-predefined remote-control codes inputted through the alphanumeric keys; (b) a remote-control code database for storing a predefined set of remote-control codes; (c) a voice-sample database for storing a predefined set of voice-samples that are used for voice recognition; (d) a voice-input unit for picking up user's natural voice command and converting the voice command into a digital voice signal; (e) a voice-recognition unit, which is capable of performing a voice recognition algorithm on the output digital voice signal from the voice-input unit to thereby recognize the voice command, and which is further capable of retrieving the remote-control code corresponding to the recognized voice command from the remote-control code database; and (f) a wireless signal emitter, which is capable of modulating the retrieved remote-control code from the remote-control code database into a wireless signal and emitting the wireless signal toward the electrical apparatuses to cause one or more of the electrical apparatuses to operate accordingly.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the utilization of the wireless-keyboard based voice-control module of the invention for remote control of various kinds of electrical apparatuses; and

FIG. 2 is a schematic diagram showing the internal architecture of the wireless-keyboard based voice-control module of the invention.

### DETAILED DESCRIPTION OF PREFERRED EMBODIMENTS

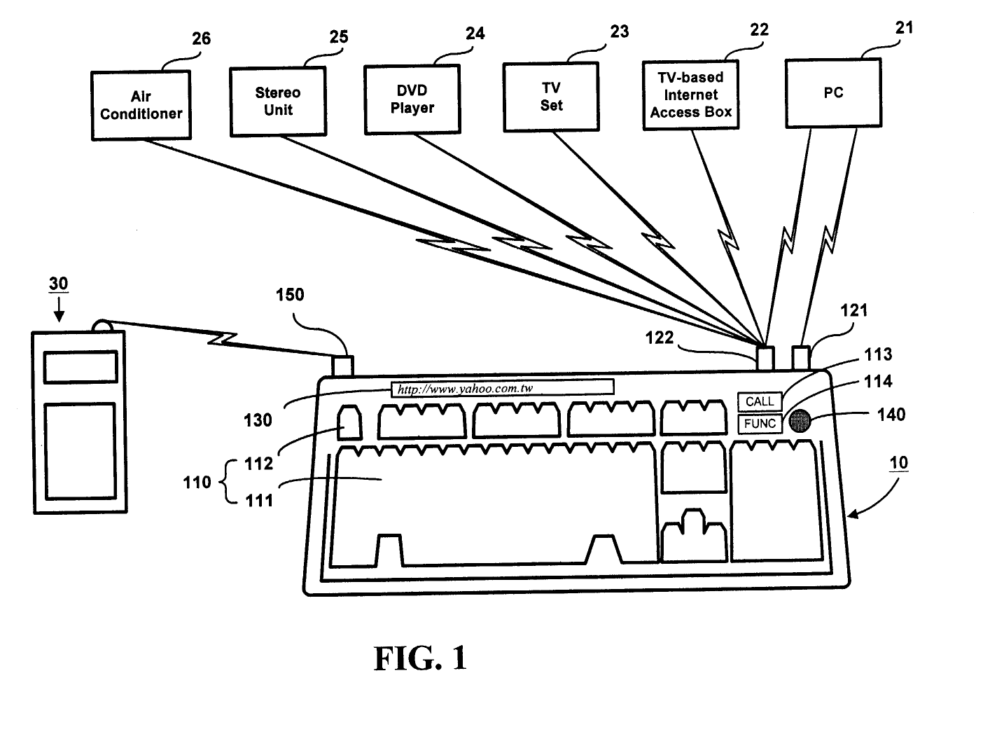

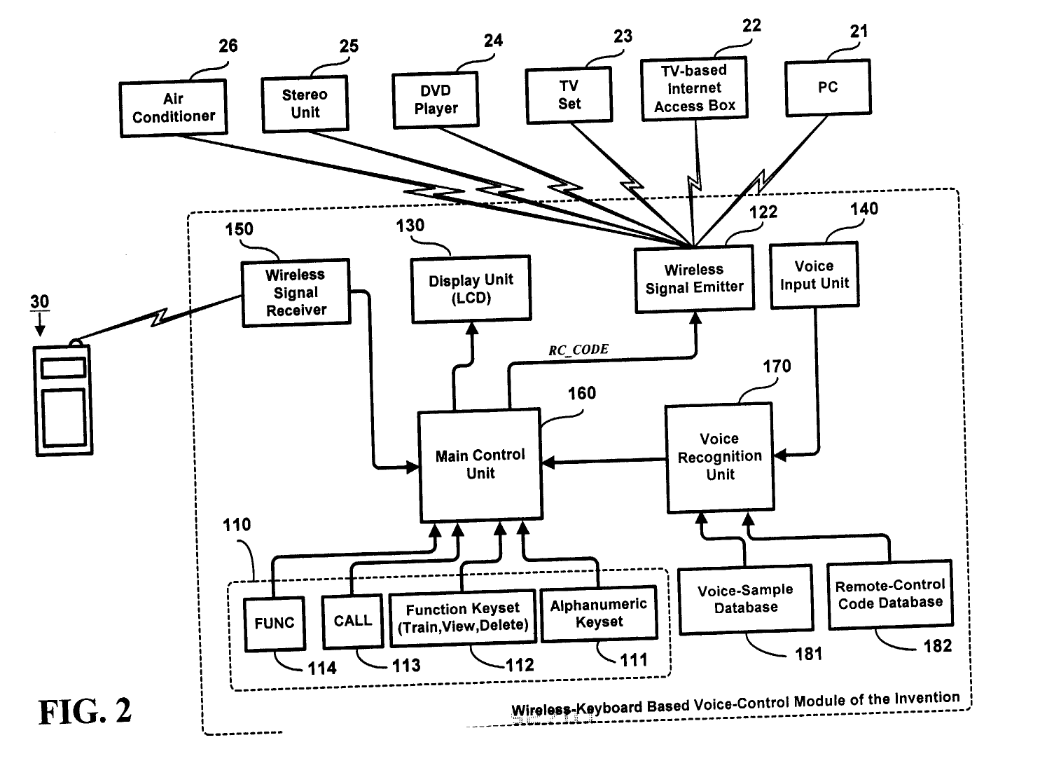

The wireless-keyboard based voice-control module of the invention is disclosed in full details by way of preferred embodiments in the following with reference to FIG. 1 and FIG. 2.

Referring first to FIG. 1, the wireless-keyboard based voice-control module of the invention is specifically designed for installation in a wireless keyboard 10 to allow the user to remotely control the operations of one or more electrical apparatuses, such as a personal computer (PC) 21, a TV-based Internet-access box 22, a TV set 23, a DVD player 24, a stereo unit 25, and an air conditioner 26, through voice activation by way of the wireless keyboard 10.

Referring to FIG. 2 together with FIG. 1, the wireless keyboard 10 includes a standard key set 110 having a subset of standard alphanumeric keys (A-Z, 0-9, and special symbols) 111 and a subset of standard function keys (F1-F12) 112, and further includes a wireless keycode emitter 121 for emitting the keycode signals that are generated by pressing the alphanumeric keys 111 and function keys 112 to the PC 21 and/or the TV-based Internet-access box 22. Normally, the wireless keyboard 10 is used in conjunction with the PC 21 and/or TV-based Internet-access box 22 for data input purpose, and when needed, can be switched to activate the voice-control module of the invention installed in the wireless keyboard 10 to perform voice-activated remote control functions on one or more of the electrical apparatuses 21, 22, 23, 24, 25, 26 through voice activation by way of the wireless keyboard 10.

As shown in FIG. 2, the wireless-keyboard based voice-control module of the invention comprises a wireless signal emitter 122, a display unit 130, a voice-input unit 140, a wireless signal receiver 150, a main control unit 160, a voice-recognition unit 170, a voice-sample database 181, and a remote-control code database 182.

The voice-control module of the invention allows the user to remotely turn on/off and control the operations of one or more of the electrical apparatuses 21, 22, 23, 24, 25, 26 through voice-activation by way of the wireless keyboard 10; i.e., the user needs just to utter a voice command against the voice-input unit 140 of the voice-control module of the invention installed in the wireless keyboard 10, and the voice-control module of the invention will be automatically activated to send out the corresponding remote-control code from the wireless signal emitter 122 to cause one or more of the electrical apparatuses 21, 22, 23, 24, 25, 26 to operate accordingly. The remote-control code can be, for example, a character string or a sequence of control code be inputted to the PC 21 and/or the TV-based Internet-access box 22, a remote control command to the TV set 23, a remote control command to the DVD player 24, a remote control command to the stereo unit 25, or a remote control command to the air conditioner 26.

For example, the user can preset the character string “http://www.yahoo.com” corresponding to the voice command “yahoo” in training mode; and afterwards, the user needs just to utter the voice command “yahoo” in his/her natural voice against the voice-input unit 140, and it will cause the voice-control module of the invention installed in the wireless keyboard 10 to send out the corresponding character string “http://www.yahoo.com” from the wireless signal emitter 122 to the surrounding environment, causing the Internet browser program on the PC 21 and/or the TV-based Internet-access box 22 to jump to the YOHOO site on the Internet. In addition, if the user wants to turn on the TV set 23, he/she needs just to utter the corresponding voice commands, such as “TV ON”, and it will cause the voice-control module of the invention installed in the wireless keyboard 10 to remotely turn on the TV set 23. After the TV set 23 is turned on, the user can further switch it to the desired channel and adjust the volume by saying, for example, “HBO” and “LOUDER”, and the voice-control module of the invention installed in the wireless keyboard 10 will be in the wireless keyboard 10 will be activated to send out the corresponding remote-control codes to cause the TV set 23 to turn to the requested channel HBO and then turn up the volume by one step. If the user wants to turn on the air conditioner 24, he/she needs just to utter the corresponding voice command, such as “AIR CONDITIONER ON”, and it will cause the voice-control module of the invention installed in the wireless keyboard 10 to remotely turn on the air conditioner 26. After that, the user can further set it to the desired temperature by saying, for example, “25 DEGREE”, and the voice-control module of the invention installed in the wireless keyboard 10 will be activated to send out the corresponding remote-control code to cause the air conditioner 26 to set the air-conditioned temperature to 25° C.

When the TV set 23 or stereo unit 25 is turned on and broadcasting a program, the broadcast sounds would degrade voice-recognition sensitivity, making the voice-control module of the invention installed in the wireless keyboard 10 unable to correctly recognize the user's voice commands at this time. As a solution to this problem, the voice-control module of the invention installed in the wireless keyboard 10 is further included with an initial mute function, which is automatically activated immediately after the initialization function is activated (by pressing the CALL key 113), and which is used to set all sound-broadcasting electrical apparatuses, such as the TV set 23 and the stereo unit 25, temporarily to mute mode. After the user's voice command input and recognition is completed, the voice-control module of the invention installed in the wireless keyboard 10 will promptly send out a de-mute signal to cause the TV set 23 and the stereo unit 25 to resume their original volumes. For a combined system of two or more electrical apparatuses, such as a combination system of the TV set 23 and the DVD player 24, the voice-control module of the invention installed in the wireless keyboard 10 is further capable of turning on both the TV set 23 and the DVD player 24 at the same time by combining the two respective power-on control codes into a single code sequence to be activated by a single voice command by the user.

The standard key set 110 on the wireless keyboard 10 includes a subset of alphanumeric keys (A-Z, 0-9, and special symbols) 111 and a subset of function keys (F1-F12) 112. To facilitate the implementation of the invention, the panel of the wireless keyboard 10 is further provided with a call key (CALL) 113 and a voice function key (FUNC) 114. The alphanumeric keys 111 and the function keys 112 are normally used for data input to the PC 21 and/or the TV-based Internet-access box 22; and in addition, they are employed by the invention to allow the user to perform training tasks, i.e., to preset voice commands and corresponding remote-control codes into the voice-control module of the invention. The voice function key (FUNC) 114 is used in combination with the standard function keys (F1-F12) 112 for the training, viewing, and deleting of preset remote-control codes in the voice-control module of the invention. For example, the combination of the voice function key (FUNC) 114 with the standard F4 key allows the user to preset a voice command and its corresponding remote-control code into the voice-control module of the invention; the combination of the same with the standard F5 key allows the user to delete a preset voice command and its corresponding remote-control code from the voice-control module of the invention; and the combination of the same with the standard F6 key allows the user to view all the preset remote-control codes stored in the voice-control module of the invention, which are to be displayed on the display unit 130. These function key combinations are design choice and not intended to limit the scope of the invention.

The wireless signal emitter 122 is preferably an infrared (IR) type that can modulate digital remote-control code into infrared signal and transmit it to the surrounding environment. The use of infrared technology allows the voice-control module of the invention to be compatible with most of the remotely-controllable electrical apparatuses in the consumer market. However, other types of wireless transmission technologies are applicable.

The display unit 130 can be, for example, an LCD (Liquid Crystal Display), which is used to display the alphanumeric characters representative of a preset character string or remote-control command that are inputted by the user through the alphanumeric keys 111 under training mode, for the user to verify whether his/her preset remote-control code is correct or not. In addition, the display unit 130 can be used to display operation cues and preset remote-control codes.

The voice-input unit 140 is a combined module of microphone plus analog-to-digital function, which is capable of picking up the user's natural voice command and converting it into digital voice signal.

The wireless signal receiver 150 is preferably an infrared (IR) type for compatibility with most of the remotely-controllable electrical apparatuses in the consumer market. It is used in training mode to receive all the remote-control codes of a dedicated remote controller 30 of a certain electrical apparatus, and then duplicate the received remote-control code and store it in the remote-control code database 182.

The main control unit 160 can be either a microcontroller or a specific-purpose logic circuit, which is coupled to the key set 110, the wireless keycode emitter 121, the wireless signal emitter 122, the display unit 130, the wireless signal receiver 150, and the voice-recognition unit 170 for control the operations thereof and the data communications therebetween.

The voice-recognition unit 170 is capable of performing a special voice recognition algorithm on the output digital voice signal from the voice-input unit 140 to thereby recognize the user's voice command. The voice-recognition unit 170 can be either a dedicated chip or a microprocessor with built-in voice-recognition software/firmware. The voice recognition algorithm utilized by the voice-recognition unit 170 is conventional technology, so description thereof will not be further detailed.

The voice-sample database 181 and the remote-control code database 182 are both reprogrammable data storage means, such as flash memory. The voice-sample database 181 is used to store a predefined set of voice-samples that are used to compare against each user-input voice command for recognition of the voice command. The remote-control code database 182 is used to store a predefined set of remote-control codes which are either factory-preset or user-preset. These remote-control codes can be preset into the voice-control module of the invention and stored in the remote-control code database 182 in two methods: (1) by directly inputting manufacturer-specified remote-control codes, which can be obtained from the manufacturers of the electrical apparatuses 21, 22, 23, 24, 25, 26; and (2) by duplicating the output remote-control codes from the dedicated remote controller of each of the electrical apparatuses 21, 22, 23, 24, 25, 26. By the first method, all the remote-control codes specific to the electrical apparatuses 21, 22, 23, 24, 25, 26 are obtained from their respective manufacturers, and then each remote-control code is assigned to a unique number corresponding to a unique voice command. After this, the all the remote-control codes together with their uniquely assigned numbers are stored into the remote-control code database 182. By the second method, the voice-control module of the invention utilizes the wireless signal receiver 150 to receive all the output remote-control codes from the dedicated remote controller 30 of each of the electrical apparatuses 21, 22, 23, 24, 25, 26, and then duplicate the received remote-control codes and store them in the remote-control code database 182. These two methods are both known conventional technologies, so that details steps thereof will not be further described.

The user can normally use the wireless keyboard 10 for wireless data input to the PC 21 and/or the TV-based Internet-access box 22, and when needed, can use the CALL key 113 to activate the voice-control module of the invention installed in the wireless keyboard 10 for voice-activated data input to the PC 21 and/or TV-based Internet-access box 22 and for voice-activated remote control of the TV-based Internet-access box 22, the TV set 23, the DVD player 24, the stereo unit 25, and/or the air conditioner 26. When the CALL key 113 is pressed, it sets the voice-control module of the invention to STANDBY mode, ready to receive any voice command from the user. The use of the CALL key 113 prevents any chats or unrelated sounds to activate an unintended remote control.

Moreover, the user can use the voice function key (FUNC) 114 in combination of one or more of the standard function keys (F1-F12) 112 to perform training, viewing, and deleting of preset remote-control codes and voice commands. For example, the combination of the voice function key (FUNC) 114 with the standard F4 key allows the user to preset a voice command and its corresponding remote-control code into the remote-control code database 182; the combination of the same with the standard F5 key allows the user to delete a preset voice command and its corresponding remote-control code from the remote-control code database 182; and the combination of the same with the standard F6 key allows the user to view all the preset remote-control codes and corresponding voice commands currently stored in the remote-control code database 182.

Under training mode, each user-defined remote-control code is displayed on the display unit 130 for verification. The keycodes that are generated by the user pressing the alphanumeric keys 111 can be transferred to the display unit 130 in two ways, either by providing another wireless receiver (not shown) to receive the output wireless signal from the wireless keycode emitter 121 and then transferring the received keycodes to the display unit 130, or by internally wiring the alphanumeric keys 111 to the display unit 130. The latter scheme, however, would require modifications to the existing hardware architecture of the wireless keyboard 10.

As the voice-control module of the invention installed in the wireless keyboard 10 is set in STANDBY mode, the user needs just to utter a voice command against the voice-input unit 140, and it will cause the voice-control module of the invention to send out a wireless signal representative of the corresponding remote-control code from the wireless signal emitter 122 to cause one or more of the electrical apparatuses 21, 22, 23, 24, 25, 26 to operate accordingly.

The output digital voice signal from the voice-input unit 140 is sent to the voice-recognition unit 170 where a special voice recognition algorithm is performed to compare the digital voice signal against all the voice-samples stored in the voice-sample database 181 to thereby determine the user's voice command. If the recognition is successful, the voice-recognition unit 170 will retrieve the corresponding remote-control code (represented by RC_CODE) from the remote-control code database 182 and then transfer it via the main control unit 160 to the wireless signal emitter 122.

At the wireless signal emitter 122, the remote-control code RC_CODE is modulated into an wireless signal, such as an IR signal, and then emitted outwards to the surrounding environment. Since the wireless signal emitter 122 is designed to have an omni-directional capability, it allows the emitted wireless signal to be received by all of the electrical apparatuses 21, 22, 23, 24, 25, 26 located nearby the wireless keyboard 10. The wireless signal then causes one or more of the electrical apparatuses 21, 22, 23, 24, 25, 26 that are responsive to the remote-control code RC_CODE to operate accordingly.

In conclusion, the invention provides a wireless-keyboard based voice-control module with display unit, which is designed specifically for installation on a wireless keyboard to allow the user to remotely control the operations of various kinds of remotely-controllable electrical apparatuses through voice activation by way of the wireless keyboard. The voice-control module of the invention is characterized by the provision of a display unit that can display the user-predefined character strings or remote-control commands in training mode for user verification. The utilization of the invention is therefore convenient and efficient.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A wireless-keyboard based voice-control module for use on a wireless keyboard for remote control of one or more electrical apparatuses through user voice activation by way of the wireless keyboard; the wireless keyboard including a standard key set and a wireless keycode emitter; the key set including a subset of alphanumeric keys and a subset of function keys;
the wireless-keyboard based voice-control module comprising:
(a) a display unit, which is capable of displaying user-input alphanumeric characters representative of user-predefined remote-control codes inputted through the alphanumeric keys;
(b) a remote-control code database for storing a predefined set of remote-control codes;
(c) a voice-sample database for storing a predefined set of voice-samples that are used for voice recognition;
(d) a voice-input unit for picking up user's natural voice command and converting the voice command into a digital voice signal;
(e) a voice-recognition unit, which is capable of performing a voice recognition algorithm on the output digital voice signal from the voice-input unit to thereby recognize the voice command, and which is further capable of retrieving the remote-control code corresponding to the recognized voice command from the remote-control code database; and
(f) a wireless signal emitter, which is capable of modulating the retrieved remote-control code from the remote-control code database into a wireless signal and emitting the wireless signal toward the electrical apparatuses to cause one or more of the electrical apparatuses to operate accordingly.

2. The wireless-keyboard based voice-control module of claim 1, further comprising:
a wireless signal receiver, which is used in training mode to receive remote-control codes of a dedicated remote controller of an electrical apparatuses being intended to be remotely controlled, for duplicating the received remote-control code and store it in the remote-control code database.

3. The wireless-keyboard based voice-control module of claim 1, further comprising:
a call key for triggering an initialization function to set the wireless-keyboard based voice-control module to standby mode, and subsequently an initial mute function which is activated immediately after the initialization function is activated, for setting all of the electrical apparatuses to mute mode.

4. The wireless-keyboard based voice-control module of claim 1, wherein the wireless signal emitter is an infrared type of wireless signal emitter.

5. The wireless-keyboard based voice-control module of claim 2, wherein the wireless signal receiver is an infrared type of wireless signal receiver.

6. The wireless-keyboard based voice-control module of claim 1, wherein the display unit is an LCD.

7. The wireless-keyboard based voice-control module of claim 1, further comprising:
a voice function key, which is used in combination with the standard function keys of the wireless keyboard, for performing training, viewing, and deleting of preset remote-control codes and corresponding voice commands stored in the remote-control code database.

8. The wireless-keyboard based voice-control module of claim 1, wherein the display unit is further used to display operation cues.
